(19) United States
(12) Patent Application Publication
(10) Pub. No.: US 2015/0169153 A1
(43) Pub. Date: Jun. 18, 2015

(54) ENHANCING A VIEWING AREA AROUND A CURSOR

(71) Applicant: LENOVO (Singapore) PTE, LTD., New Tech Park (SG)

(72) Inventors: Alfredo Zugasti Hays, Cary, NC (US); Bruce Douglas Gress, Raleigh, NC (US); Robert James Kapinos, Durham, NC (US); Alex Ramirez Flores, Cary, NC (US); Jose Rodolfo Ruiz, Raleigh, NC (US)

(73) Assignee: LENOVO (Singapore) PTE, LTD., New Tech Park (SG)

(21) Appl. No.: 14/109,630

(22) Filed: Dec. 17, 2013

(51) Int. Cl. G06F 3/0484; G06F 3/0481

(52) U.S. Cl. CPC G06F 3/0484; G06F 3/0481

(57) ABSTRACT

A method, apparatus, and program product are disclosed for positioning a cursor on a clicking area, the cursor being displayed on a display of an information handling device, receiving an input action from a user, the input action detected by an input detector, and enhancing a viewing area around the cursor in response to the input action, wherein items within the enhanced viewing area are visually larger than items outside the enhanced viewing area.

### BACKGROUND

1. Field

The subject matter disclosed herein relates to gesture input and more particularly relates to enhancing a viewing area around a cursor to provide more accurate click gestures.

2. Description of the Related Art

Gesture recognition allows a user to interact with an information handling device, such as a computer, using hand gestures, facial gestures, etc. For example, a user may move a cursor around an interface by using a hand or an extended finger on the hand. The user may also interact with the interface by “clicking” on interactive elements, such as buttons, hyperlinks, etc. displayed on the interface by using a clicking gesture. However, it may be difficult to “click” an interactive element using a hand gesture because, in order to “click” the interactive element, the hand will inevitably move, which may move the cursor off of the interactive element.

### BRIEF SUMMARY

A method for enhancing a viewing area around a cursor is disclosed. An apparatus and computer program product also perform the functions of the method.

In one embodiment, a method is described that includes positioning a cursor on a clicking area, the cursor being displayed on a display of an information handling device. In some embodiments, the method includes receiving an input action from a user. In certain embodiments, the input action is detected by an input detector. In another embodiment, the method includes enhancing a viewing area around the cursor in response to the input action such that items within the enhanced viewing area are visually larger than items outside the enhanced viewing area.

In one embodiment, the method includes enhancing the viewing area around the cursor in response to detecting a deceleration of a movement speed of the cursor. In a further embodiment, the method includes removing the enhancement of the viewing area around the cursor in response to detecting an acceleration of a movement speed of the cursor. In another embodiment, the viewing area around the cursor is persistently enhanced. In certain embodiments, the method includes configuring a size of the enhanced viewing area around the cursor. The size of the enhanced viewing area, in certain embodiments, includes either a percentage of a total viewing area of the display or a specified number of pixels.

In another embodiment, the input action includes an input gesture and the input detector includes a gesture detection device. In one embodiment, the gesture detection device includes a camera. In a further embodiment, the input detector includes an input device.

The apparatus, in one embodiment, includes a processor, a display accessible to the processor, and a memory storing machine readable code executable by the processor. In one embodiment, the apparatus includes a cursor module that positions a cursor on a clicking area. In another embodiment, the cursor is displayed on a display of an information handling device. The apparatus, in some embodiments, includes an input module that receives an input action from a user, the input action detected by an input detector. In a further embodiment, the apparatus includes a magnification module that enhances a viewing area around the cursor in response to the input action such that items within the enhanced viewing area are visually larger than items outside the enhanced viewing area.

In one embodiment, the apparatus includes a deceleration module that enhances the viewing area around the cursor in response to detecting a deceleration of a movement speed of the cursor. In a further embodiment, the apparatus includes an acceleration module that removes the enhancement of the viewing area around the cursor in response to detecting an acceleration of a movement speed of the cursor. In another embodiment, the viewing area around the cursor is persistently enhanced. In certain embodiments, the apparatus includes a size configuration module that sets a size of the enhanced viewing area around the cursor. The size of the enhanced viewing area, in certain embodiments, includes either a percentage of a total viewing area of the display or a specified number of pixels.

In another embodiment, the input action includes an input gesture and the input detector includes a gesture detection device. In one embodiment, the gesture detection device comprises a camera. In a further embodiment, the input the input detector comprises an input device.

A program product is disclosed including a computer readable storage medium storing machine readable code executable by a processor to perform the operations. In one embodiment, the operations include positioning a cursor on a clicking area, the cursor being displayed on a display of an information handling device. In some embodiments, the operations include receiving an input action from a user. In certain embodiments, the input action is detected by an input detector. In another embodiment, the operations include enhancing a viewing area around the cursor in response to the input action such that items within the enhanced viewing area are visually larger than items outside the enhanced viewing area.

In a further embodiment, the operations include enhancing the viewing area around the cursor in response to detecting a deceleration of a movement speed of the cursor. In another embodiment, the operations include removing the enhancement of the viewing area around the cursor in response to detecting an acceleration of a movement speed of the cursor.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for enhancing a viewing area around a cursor;

FIG. 2 is a schematic block diagram illustrating one embodiment of an apparatus for enhancing a viewing area around a cursor;

FIG. 3 is a schematic block diagram illustrating another embodiment of an apparatus for enhancing a viewing area around a cursor;

FIG. 4 illustrates one embodiment of moving an on-screen cursor by tracking a hand gesture;

FIG. 5 illustrates one embodiment of enhancing a viewing area around a cursor;

FIG. 6 illustrates one embodiment of enabling and disabling enhancement of the viewing area around the cursor based on the cursor's movement speed;

FIG. 7 is a schematic flow chart diagram illustrating one embodiment of a method for enhancing a viewing area around a cursor; and

FIG. 8 is a schematic flow chart diagram illustrating another embodiment of a method for enhancing a viewing area around a cursor.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code. The storage devices may be tangible, non-transitory, and/or non-transmission.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in machine readable code and/or software for execution by various types of processors. An identified module of machine readable code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of machine readable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices, and may exist, at least partially, merely as electronic signals on a system or network. Where a module or portions of a module are implemented in software, the software portions are stored on one or more computer readable storage devices.

Any combination of one or more computer readable medium may be utilized. The computer readable medium may be a machine readable signal medium or a storage device. The computer readable medium may be a storage device storing the machine readable code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A machine readable signal medium may include a propagated data signal with machine readable code embodied therein, for example, in baseband or as part of a carrier wave. Such a propagated signal may take any of a variety of forms, including, but not limited to, electro-magnetic, optical, or any suitable combination thereof. A machine readable signal medium may be any storage device that is not a computer readable storage medium and that can communicate, propagate, or transport a program for use by or in connection with an instruction execution system, apparatus, or device. Machine readable code embodied on a storage device may be transmitted using any appropriate medium, including but not limited to wireless, wireline, optical fiber cable, Radio Frequency (RF), etc., or any suitable combination of the foregoing.

Machine readable code for carrying out operations for embodiments may be written in any combination of one or more programming languages, including an object oriented programming language such as Java, Smalltalk, C++ or the like and conventional procedural programming languages, such as the “C” programming language or similar programming languages. The machine readable code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by machine readable code. These machine readable code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The machine readable code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The machine readable code may also be loaded onto a computer, other programmable data processing apparatus, or other devices to cause a series of operational steps to be performed on the computer, other programmable apparatus or other devices to produce a computer implemented process such that the program code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and machine readable code.

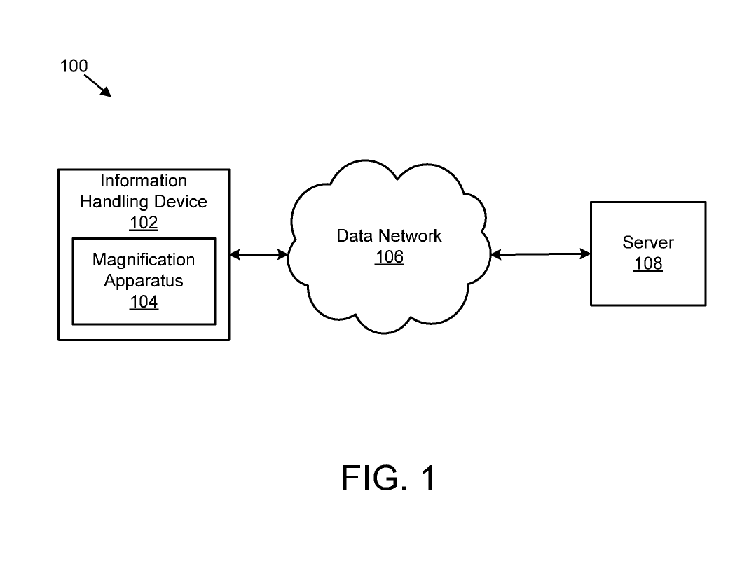

Descriptions of Figures may refer to elements described in previous Figures, like numbers referring to like elements. FIG. 1 depicts one embodiment of a system 100 for enhancing a viewing area around a cursor. In one embodiment, the system 100 includes an information handling device 102, a magnification apparatus 104, a data network 106, and a server 108, which are described in more detail below.

In one embodiment, the system 100 includes an information handling device 102. In some embodiments, the information handling device 102 receives input from an input device, such as a mouse, joystick, track pad, and/or the like. The information handling device 102, in certain embodiments, includes a touch-enabled display that recognizes and receives input from a touch input device, such as a stylus, a user's finger, and/or the like. In another embodiment, the information handling device 102 receives gesture input from a gesture input detector, such as a digital camera, an infrared camera, and/or the like. In some embodiments, the information handling device 102 includes a mobile device, such as a smart phone, tablet computer, PDA, and/or the like. In another embodiment, the information handling device 102 includes a laptop computer, a desktop computer, a smart TV, and/or the like.

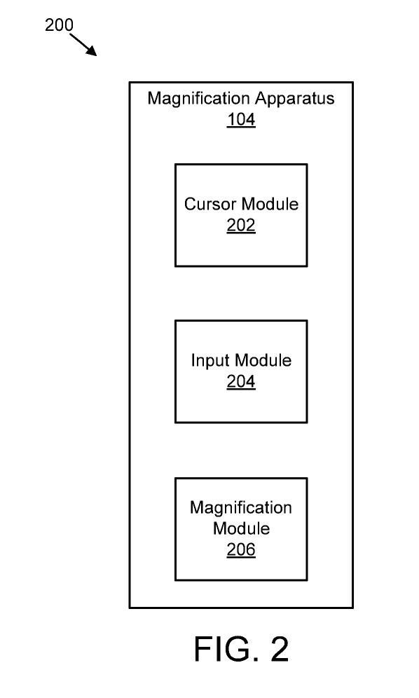

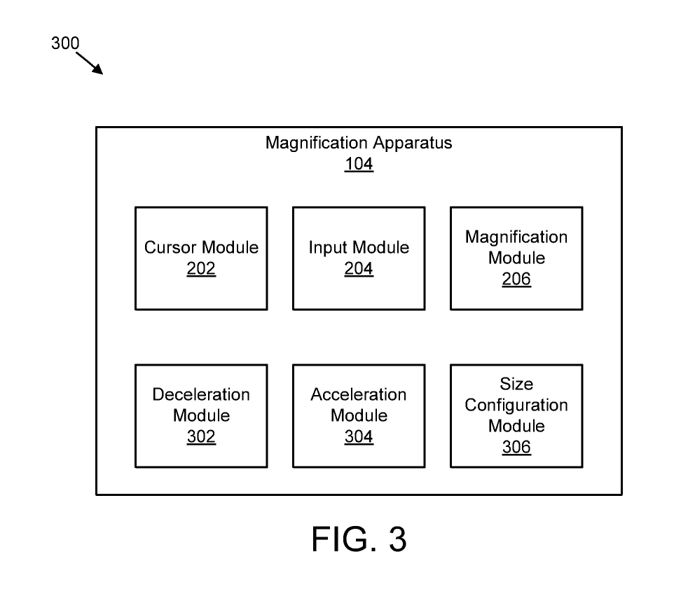

In one embodiment, the system 100 includes a magnification apparatus 104, which positions a cursor on a clicking area presented on a display of an information handling device 102. As used herein, a cursor is an indicator used to show the position on a display or other display device that will respond to input from a user. In another embodiment, the magnification apparatus 104 receives an input action from a user, which is detected by an input detector. In a further embodiment, the magnification apparatus 104 enhances a viewing area around the cursor in response to the input action such that items within the enhanced viewing area are visually larger than items outside the enhanced viewing area. The magnification apparatus 104, in one embodiment, includes one or more modules that perform the operations associated with enhancing a viewing area around a cursor. The magnification apparatus 104, including its associated modules, are described in more detail below with reference to FIGS. 2 and 3.

In another embodiment, the system 100 includes a data network 106. The data network 106, in certain embodiments, is a digital communication network 106 that transmits digital communications related to enhancing a viewing area around a cursor. The digital communication network 106 may include a wireless network, such as a wireless telephone network, a local wireless network, such as a Wi-Fi network, a Bluetooth® network, and the like. The digital communication network 106 may include a wide area network (“WAN”), a storage area network (“SAN”), a local area network (“LAN”), an optical fiber network, the internet, or other digital communication network known in the art. The digital communication network 106 may include two or more networks. The digital communication network 106 may include one or more servers, routers, switches, and/or other networking equipment. The digital communication network 106 may also include computer readable storage media, such as a hard disk drive, an optical drive, non-volatile memory, random access memory (“RAM”), or the like.

The system 100, in another embodiment, includes a server 108. The server 108, in some embodiments, includes a main frame computer, a desktop computer, a laptop computer, a cloud server, and/or the like. In certain embodiments, the server 108 includes at least a portion of the magnification apparatus 104. In another embodiment, the information handling device 102 is communicatively coupled to the server 108 through the data network 106. In another embodiment, the information handling device 102 offloads at least a portion of the information processing related to enhancing a viewing area around a cursor (e.g., input and/or gesture detection processing, enhancement processing, and/or the like) to the server 108.

FIG. 2 depicts one embodiment of an apparatus 200 for enhancing a viewing area around a cursor. In certain embodiments, the apparatus 200 includes a magnification apparatus 104. The magnification apparatus 104, in another embodiment, includes a cursor module 202, an input module 204, and a magnification module 206, which are described below in more detail.

The magnification apparatus 104, in one embodiment, includes a cursor module 202 that positions a cursor on a clicking area. In certain embodiments, the cursor is displayed on a display of an information handling device 102. For example, the cursor may be displayed on a desktop of an operating system, in a web browser, and/or any graphical application executing on an information handling device 102. The clicking area, in certain embodiments, includes an interactive area displayed on the display of the information handling device 102. For example, the clicking area may include an interactive user interface element, such as a button, a drop-down menu, an image, a hyperlink, a video player, an icon, and/or the like.

In certain embodiments, the magnification apparatus 104 includes an input module 204 that receives an input action from a user using an input detector. In one embodiment, the input action includes input received from an input device, such as a mouse, keyboard, stylus, joystick, and/or the like. In certain embodiments, the input device is operably coupled to the information handling device 102. For example, input may be received from a wired or wireless mouse or keyboard. In another embodiment, the input action includes an input gesture detected by a gesture detection device. The input gesture, in some embodiments, includes a hand gesture, eye gesture, face gesture, and/or the like. In certain embodiments, the gesture detector includes a digital camera, an infrared camera, and/or the like.

In one embodiment, the cursor module 202 positions the cursor based on a user-generated input action received by the input module 204. For example, the cursor module 202 may position the cursor on the display in response to a user interacting with an input device, such as a mouse or joystick. In another example, the cursor position module 202 may position the cursor in response to the user using an input gesture to move the cursor, such as by using hand gestures, finger gestures, face gestures, or the like. One of skill in the art will recognize other methods of positioning a cursor on a display in response to user input.

In a further embodiment, the magnification apparatus 104 includes a magnification module 206 that enhances a viewing area around a cursor in response to the input module 204 receiving an input action. In one embodiment, enhancing the viewing area around the cursor makes items within the enhanced viewing area visually larger than items outside the enhanced viewing area, essentially creating a magnification or zoomed-in effect around the cursor. In this manner, the user is able to more accurately click on an interactive area, which may be especially important when using hand gestures to click on an area because it allows the user to move their hand to click on the interactive clicking-area without unwittingly moving the cursor off of the interactive clicking-area.

In certain embodiments, the magnification module 206 enhances the viewing area around the cursor using functionality provided by the operating system or another application. For example, the enhanced area may be created using the magnification functionality of the Microsoft® Windows® operating system, which may traditionally be used for accessibility purposes.

In some embodiments, the input action comprises an enhancement gesture such that the magnification module 206 enhances the viewing area around the cursor. For example, a user may make a hand gesture to enable the enhanced viewing area. In another example, a user may point with an index finger to enable the enhancement. One of skill in the art will recognize the various gestures that may be used to enable the enhancement of the viewing area around the cursor. In another embodiment, the input action comprises a reset gesture that removes the enhancement of the viewing area around the cursor. The reset action, for example, may include a hand gesture or a finger gesture, similar to the enhancement gesture.

In another embodiment, the input action includes an input received from an input device. The input action may be a button press on a mouse or a keyboard, which would enable or disable the enhancement of the viewing area around the cursor. Thus, for example, the user may move the cursor with a mouse and enable the enhanced viewing area around the cursor by pressing a button on the mouse, or a combination of buttons, or by pressing a key on the keyboard. Similarly, the user may disable the enhanced viewing area by performing the same or similar input action.

In some embodiments, the magnification module 206 maintains the enhanced viewing area around the cursor such that the viewing area around the cursor is persistently enhanced. For example, a user may configure the enhancement to be enabled without having to provide an enhancement gesture or an enhancement action. In some embodiments, the magnification module 206 persistently enables the enhanced viewing area around the cursor in response to receiving an input action that locks the enhancement in an enabled state. For example, the user may press the space bar a certain number of times or wave their hand in front of the gesture detector a certain number of times in order to provide an enhancement-locking action, which would lock the enhancement in an enabled state.

In some embodiments, the magnification module 206 enables the enhanced viewing area around the cursor in response to the cursor module 202 positioning the cursor over an interactive clicking area. In such an embodiment, the input action would be sent in response to the cursor entering the clicking area. Similarly, in some embodiments, the enhanced viewing area is disabled in response to the cursor module 202 moving the cursor outside of the clicking area. In one embodiment, after the magnification module 206 enables the enhanced viewing area, the enhanced viewing area may be disabled after a predefined period of time. For example, after the magnification module 206 enhances the viewing area around the cursor in response to the user moving the cursor to an interactive button, the magnification module 206 may only enable the enhanced viewing area for a predefined period of time, such as five seconds, ten seconds, or the like, before disabling the enhanced area. The user, in certain embodiments, defines the amount of time that the magnification module 206 enhances the viewing area.

FIG. 3 depicts another embodiment of an apparatus 300 for enhancing a viewing area around a cursor. In one embodiment, the apparatus 300 includes a magnification apparatus 104. The magnification apparatus 104, in certain embodiments, includes a cursor module 202, an input module 204, and a magnification module 206, which are substantially similar to the cursor module 202, input module 204, and magnification module 206 described with reference to FIG. 2. The magnification apparatus 104, in a further embodiment, includes a deceleration module 302, an acceleration module 304, and a size configuration module 306, which are described below.

The magnification apparatus 104, in one embodiment includes a deceleration module 302 that enhances the viewing area around the cursor in response to detecting a deceleration of a movement speed of the cursor. For example, as the user moves the cursor across the display, the deceleration module 302 may detect a deceleration in the speed of the cursor movement and, consequently, enhance the viewing area around the cursor. The user, for example, may be moving a cursor to a button, and, as the user slows the cursor down to position the cursor on the button, the deceleration module 302 may enhance the viewing area around the cursor in order to make clicking on the button easier.

In one embodiment, the deceleration module 302 enhances the viewing area around the cursor in response to the movement speed of the cursor being below a threshold speed. For example, the deceleration module 302 may detect the movement speed of the cursor slowing down, but will not enhance the viewing area around the cursor until the movement speed is below a threshold speed. In a further embodiment, the deceleration module 302, in response to detecting a deceleration of a movement of the cursor, triggers an action such that the magnification module 206 enhances the viewing area around the cursor.

The magnification apparatus 104, in one embodiment includes an acceleration module 304 that removes the enhancement of the viewing area around the cursor in response to detecting an acceleration of a movement speed of the cursor. For example, as the user moves the cursor across the display, the acceleration module 304 may detect an acceleration in the speed of the cursor movement and, consequently, remove the enhancement of the viewing area around the cursor. The user, for example, may be moving a cursor from a stationary position, and, as the user moves the cursor faster, the acceleration module 304 may remove any enhancement of the viewing area around the cursor.

In one embodiment, the acceleration module 304 removes the enhancement of the viewing area around the cursor in response to the movement speed of the cursor being above a threshold speed. For example, the acceleration module 304 may detect an increase in the movement speed of the cursor, but will not remove the enhancement of the viewing area around the cursor until the movement speed is above a threshold speed. In a further embodiment, the acceleration module 304, in response to detecting an acceleration of a movement of the cursor, triggers an action such that the magnification module 206 removes the enhancement of the viewing area around the cursor.

The magnification apparatus 104, in another embodiment includes a size configuration module 306 that sets a size of the enhanced viewing area around the cursor. In certain embodiments, the enhanced viewing area around the cursor is the shape of a circle having a predetermined radius. The size configuration module 306, in one embodiment, receives size configuration data, such as a radius of the enhancement circle, and sets the size of the enhancement circle to the received radius. The size configuration module 306, in certain embodiments, receives size configuration data for enhancement areas of various shapes, such as a square, a diamond, a triangle, and/or the like. For example, the size configuration module 306 may receive a side length of a square or rectangle, an area of a triangle, and/or the like. The user, in certain embodiments, specifies the shape of the enhanced viewing area around the cursor, such that the cursor is the center of the enhanced viewing shape.

In some embodiments, the size of the enhanced viewing area includes a percentage of a total viewing area of the display, a specified number of pixels, and/or the like. Thus, for example, a user may specify that an enhanced viewing area in the shape of a circle have a radius of 10 pixels. Alternatively, the user may specify that an enhanced viewing area in the shape of a square has a size that is 2% of the total viewing area of the display.

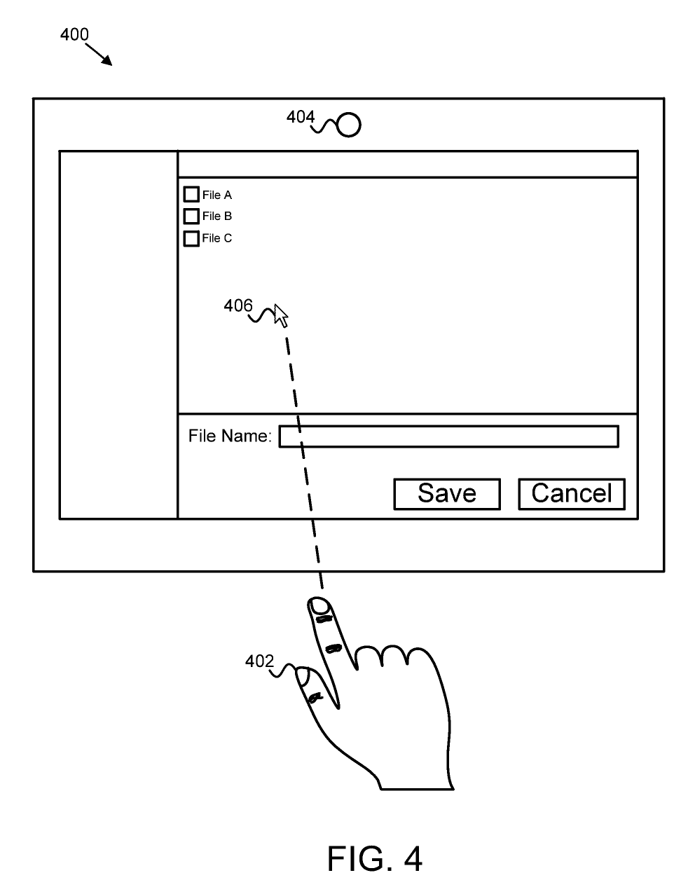

FIG. 4 depicts one embodiment 400 of moving an on-screen cursor by tracking a hand gesture 402. In the depicted embodiment 400, a hand gesture 402 is recognized by a gesture detector 404. In certain embodiments, the gesture detector 404 includes a digital camera, an infrared camera, and/or the like. The input gesture 402, in certain embodiments, is detected to be a cursor-moving or cursor-positioning input gesture. In alternative embodiments, the cursor may be moved or positioned using an input device, such as a mouse. In response to the gesture detector 404 detecting the input gesture 402, the cursor module 202 positions a cursor 406 on the display. As the input gesture is moved, such as when the user moves his hand left to right, the cursor module 202 moves the cursor 406 synchronously with the user's hand.

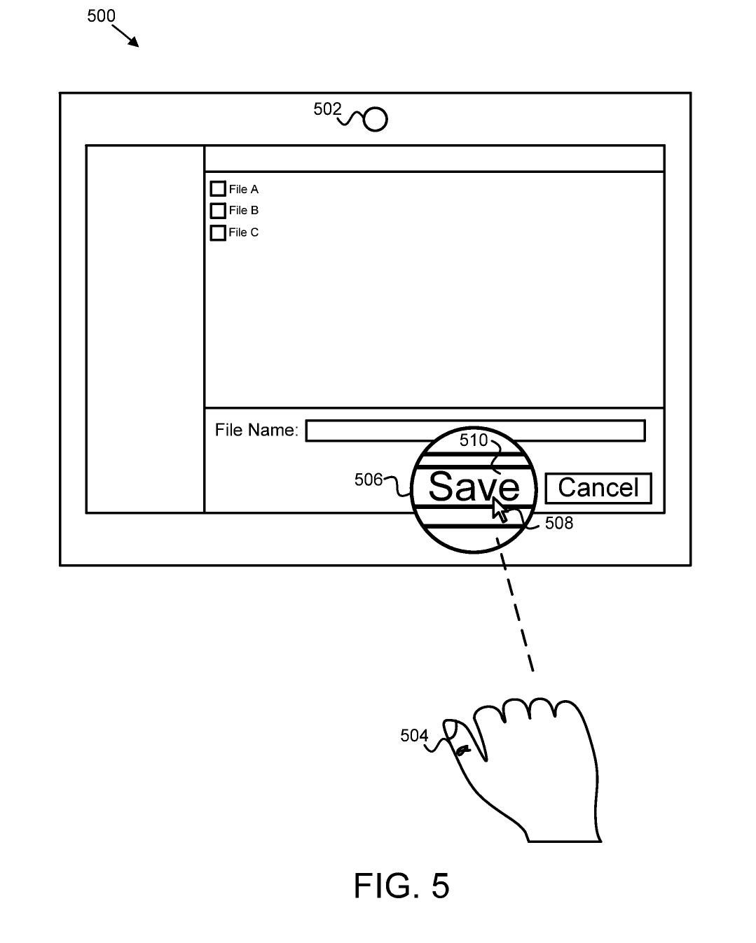

FIG. 5 depicts one embodiment 500 of enhancing a viewing area around a cursor 508. In the depicted embodiment 500, the cursor module 202 positions the cursor 508 over a clicking area, in this case an interactive “Save” button 510, in response to the user moving the cursor to that position. In a further embodiment, an input module 204 receives an input gesture 504 from the user, such as closing a pointed finger, which may be detected by an input detection device 502. The magnification module 206, in another embodiment, in response to the input gesture 504, enhances a viewing area 506 around the cursor 508, such that the items within the viewing area 506, e.g., the “Save” button 510, are larger than the items outside the viewing area 506. The user may then perform a clicking gesture with his hand without worrying about slight movements moving the cursor off of the clicking area, e.g., the button 510, which may be the case if the viewing area around the cursor 506 was not magnified.

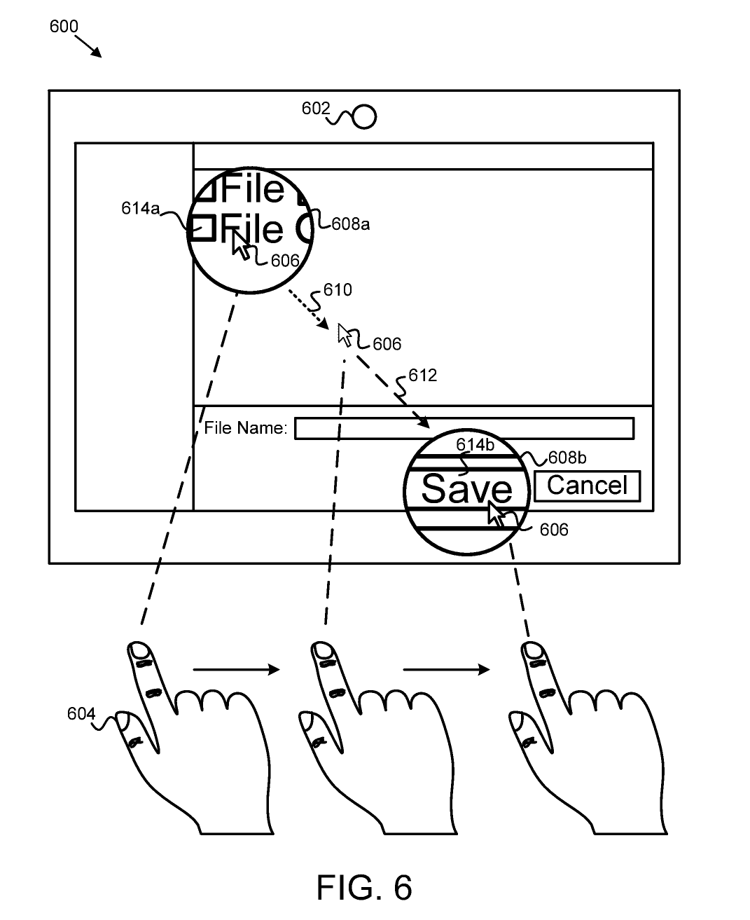

FIG. 6 illustrates one embodiment of enabling and disabling enhancement of the viewing area around the cursor based on the cursor's movement speed. In the depicted embodiment 600, the cursor module 202 has positioned the cursor 606 over a clicking area 614a and a viewing area 608a around the cursor 606 has been enhanced. The user may then move the cursor 606 using an input gesture 604 detected by a gesture detector 602. As the user moves the cursor 606, an acceleration module 304 removes the enhancement of the viewing area 608a around the cursor in response to detecting an acceleration 610 in the movement speed of the cursor 606.

As the user continues to move the cursor 606 to the clicking area 614b, the deceleration module 302 enhances the viewing area 608b around the cursor 606 in response to detecting a deceleration 612 in the movement speed of the cursor 606. As described above, the acceleration module 304 may not remove the enhanced viewing area 608a until the movement speed of the cursor 606 surpasses a predetermined threshold. Similarly, the deceleration module 302 may not enhance a viewing area 608b around the cursor 606 until the movement speed of the cursor 606 is below a predetermined threshold.

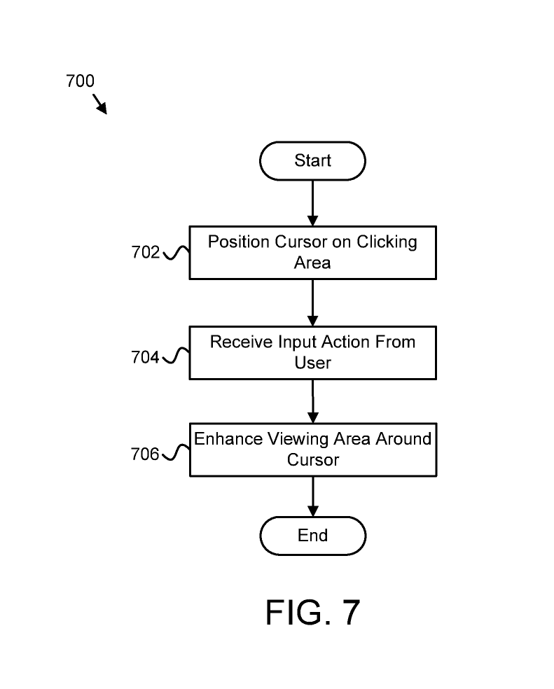

FIG. 7 depicts one embodiment of a method 700 for enhancing a viewing area around a cursor. In one embodiment, the method 700 begins and a cursor module 202 positions 702 a cursor on a clicking area. In some embodiments, the user moves the cursor to the clicking area using an input, such as a gesture or using an input device. An input module 204, in another embodiment, receives 704 an input action from the user. The input action, in certain embodiments, is detected by an input detector. In one embodiment, the input detector is a gesture detection device, such as a digital camera, and the input action includes an input gesture. In another embodiment, the input detector includes an input device, such as a mouse, keyboard, or the like, and the input action includes an input received from the input device, such as a mouse button click, a keyboard button press, or the like. In response to the input action, a magnification module 206 enhances 706 a viewing area around the cursor such that items within the enhanced area are visually larger than items outside the enhanced area. And the method 700 ends.

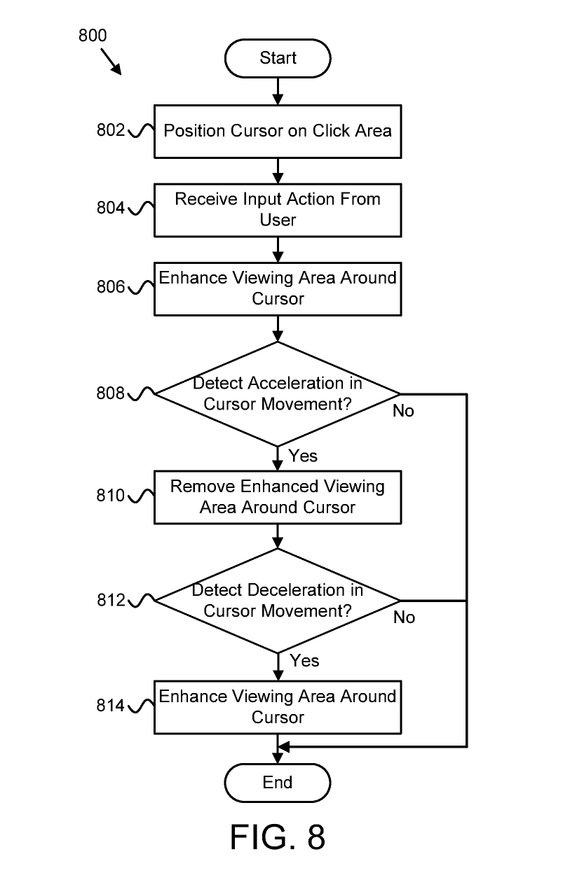

FIG. 8 depicts another embodiment of a method 800 for enhancing a viewing area around a cursor. In one embodiment, the method 800 begins and a cursor module 202 positions 802 a cursor on a clicking area. An input module 204 receives 804 an input action from the user, such as an input gesture detected using a gesture detection device or an input using an input device. In response to the input action, a magnification module 206 enhances 806 a viewing area around the cursor, such that items within the enhanced viewing area are larger than items outside the enhanced viewing area.

In one embodiment, an acceleration module 304 determines 808 whether the movement speed of the cursor is accelerating. If the acceleration module 304 does not determine 808 the movement speed of the cursor is accelerating, the method 800 ends. Otherwise, the acceleration module 304 removes 810 the enhanced viewing area around the cursor. In certain embodiments, the acceleration module 304 determines 808 the movement of the cursor is accelerating in response to the movement speed exceeding a predetermined acceleration threshold. In another embodiment, the acceleration module 304 triggers an action such that the magnification module 206 removes an enhancement of a viewing area around the cursor in response to determining 808 the cursor is accelerating.

In one embodiment, a deceleration module 302 determines 812 whether the movement speed of the cursor is decelerating. If the deceleration module 302 does not determine 812 the movement speed of the cursor is decelerating, the method 800 ends. Otherwise, the deceleration module 302 enhances 814 the viewing area around the cursor. In certain embodiments, the deceleration module 302 determines 812 the movement of the cursor is decelerating in response to the movement speed being less than a predetermined deceleration threshold. In another embodiment, the deceleration module 302 triggers an action such that the magnification module 206 enhances the viewing area around the cursor in response to determining 812 the cursor is decelerating. And the method 800 ends.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
positioning a cursor on a clicking area, the cursor being displayed on a display of an information handling device;
receiving an input action from a user, the input action detected by an input detector; and
enhancing a viewing area around the cursor in response to the input action, wherein items within the enhanced viewing area are visually larger than items outside the enhanced viewing area.

2. The method of claim 1, further comprising enhancing the viewing area around the cursor in response to detecting a deceleration of a movement speed of the cursor.

3. The method of claim 1, further comprising removing the enhancement of the viewing area around the cursor in response to detecting an acceleration of a movement speed of the cursor.

4. The method of claim 1, wherein the viewing area around the cursor is persistently enhanced.

5. The method of claim 1, further comprising configuring a size of the enhanced viewing area around the cursor.

6. The method of claim 1, wherein a size of the enhanced viewing area comprises one of a percentage of a total viewing area of the display and a specified number of pixels.

7. The method of claim 1, wherein the input action comprises an input gesture and the input detector comprises a gesture detection device.

8. The method of claim 7, wherein the gesture detection device comprises a camera.

9. The method of claim 1, wherein the input detector comprises an input device.

10. An apparatus comprising:
a processor;
a display accessible to the processor;
a memory that stores machine readable code executable by the processor;
a cursor module that positions a cursor on a clicking area, the cursor being displayed on the display;
an input module that receives an input action from a user, the input action detected by an input detector; and
a magnification module that enhances a viewing area around the cursor in response to the input action, wherein items within the enhanced viewing area are visually larger than items outside the enhanced viewing area.

11. The apparatus of claim 10, further comprising a deceleration module that enhances the viewing area around the cursor in response to detecting a deceleration of a movement speed of the cursor.

12. The apparatus of claim 10, further comprising an acceleration module that removes the enhancement of the viewing area around the cursor in response to detecting an acceleration of a movement speed of the cursor.

13. The apparatus of claim 10, wherein the viewing area around the cursor is persistently enhanced.

14. The apparatus of claim 10, further comprising a size configuration module that sets a size of the enhanced viewing area around the cursor.

15. The apparatus of claim 10, wherein a size of the enhanced viewing area comprises one of a percentage of a total viewing area of the display and a specified number of pixels.

16. The apparatus of claim 10, wherein the input action comprises an input gesture and the input detector comprises a gesture detection device.

17. The apparatus of claim 16, wherein the gesture detection device comprises a camera.

18. The apparatus of claim 10, wherein the input detector comprises an input device.

19. A program product comprising a computer readable storage medium storing machine readable code executable by a processor to perform:
positioning a cursor on a clicking area, the cursor being displayed on a display of an information handling device;
receiving an input action from a user, the input action detected by an input detector; and
enhancing a viewing area around the cursor in response to the input action, wherein items within the enhanced viewing area are visually larger than items outside the enhanced viewing area.

20. The program product of claim 19, further comprising enhancing the viewing area around the cursor in response to detecting a deceleration of a movement speed of the cursor and removing the enhancement of the viewing area around the cursor in response to detecting an acceleration of a movement speed of the cursor.
